(19) United States
(12) Patent Application Publication
(10) Pub. No.: US 2022/0232814 A1
(43) Pub. Date: Jul. 28, 2022

(54) Apparatus for Acquisition and Study of Invertebrate Species

(71) Applicant: Dan Lavoie, Ponte Vedra Beach, FL (US)

(72) Inventor: Dan Lavoie, Ponte Vedra Beach, FL (US)

(21) Appl. No.: 17/512,608

(22) Filed: Oct. 27, 2021

Related U.S. Application Data
(60) Provisional application No. 63/106,099, filed on Oct. 27, 2020.

(51) Int. Cl. A01M 3/00

(52) U.S. Cl. CPC A01M 3/005; A01M 2200/01

(57) ABSTRACT

This invention allows safe and easy capture, secure containment, visual examination and release or other disposition of small invertebrate specimens. It interfaces with a vacuum cleaner or other source of negative air pressure and is comprised of three main parts or segments: A collection segment used in capturing and containing insect specimens and the like, an attachment segment used in attaching the apparatus to a vacuum cleaner or similar suctioning device, and an intermediate screen segment used to attach these two segments and keep the specimens from being sucked into the suctioning device.

### CROSS-REFERENCE TO RELATED APPLICATIONS

This application claims the benefit and priority of U.S. Provisional Application Ser. No. 63/106,099 titled “Apparatus for Acquisition and Study of Invertebrate Specimens” filed Oct. 27, 2020, the same being incorporated herein by reference.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

### Field of the Invention

The instant invention pertains generally to vacuum apparatus for capturing insects, arachnids and similar small specimens for personal, class-room, and/or scientific observation. More particularly, the instant invention is directed to an accessory for attachment to the hose or other suction extension of a vacuum cleaner or other source of negative pressure, which can be used in a humane and efficient manner for the accomplishment of the aforesaid purposes.

### Background and Relevant Art

The instant invention pertains to a vacuum operated insect and invertebrate collection and viewing device. in particular, the arrangement of the invention is designed to make it easy to capture such creatures without harm and without fear, to be able to examine them safely within a provided clear viewing and collection area, and to be able to remove and release them unharmed into a natural environment and/or dispose of them as the situation merits. It can also serve as a safe and effective way for children, teachers, scientists, and others seeking to collect and examine insects and other such creatures to do so without touching or killing them and can thereby serve as an implement for education and exploration of the natural world.

The prior art is replete with examples of devices which either develop a vacuum or can be attached to such a device and used for the purpose of trapping, collecting and disposing of insects. Insects such as flies, ants, roaches, silverfish, mosquitoes, centipedes, stinging caterpillars, and spiders are generally considered pests and killed with dispatch when they threaten or intrude upon human interests, activities and/or environments. Flying insects can be a particular nuisance, especially when they invade any locale or activity that involves the handling, preparation or consumption of food. Sprays, swatters, and various other implements are also used to eliminate such unwanted insects.

In all of these situations, there are now known and available devices that use a vacuum to capture insects and (typically) deposit them into a bag or container for disposal. These normally use an elongated tube (with or without a funnel at its end) under negative pressure which can be brought near enough to the insect for the insect to be suctioned into the tube/funnel and then into the containment means provided for subsequent disposal. Some even provide an electrical grid into which such insects are sucked in order to be killed by electrocution.

While some components of the invention can be found in such prior art devices, the primary objects of this invention are different from the aforesaid devices. The instant invention also incorporates unique and non-obvious improvements that not only set it apart from prior art, but better serve not only the general purpose of the invention, but its more specialized purpose in providing a means for safely collecting, examining, and making disposition of the small creatures it is used to collect (hereinafter also referred to as “specimens”) without being as apt to harm or kill them in the process. In fact, the invention provides a much improved opportunity to capture and study insects without harming them, and further perfects the means for doing so without touching them and without risking bites or stings in the process. In all of these aspects, as well as in its simplicity of construction, operation, and versatility it represents a substantial improvement over prior art for its intended purposes.

### SUMMARY AND OBJECTS OF THE INVENTION

The above purposes are achieved in a live specimen capture and viewing arrangement intended to allow safe and easy capture, secure containment, visual examination and release or other disposition of specimens such as insects and similar invertebrates. The arrangement is designed to interface with a vacuum cleaner or other source of negative air pressure and is comprised of three main parts or segments: A collection segment used in capturing and containing insect specimens and the like, an attachment segment used in attaching the apparatus to a vacuum cleaner or similar suctioning device, and an intermediate screen segment used to attach these two segments and keep the specimens from being, sucked into the suctioning device.

The collection segment includes a nozzle section that is advantageously configured as a generally cylindrical tube which has an open end for collection purposes and thereafter flares to form an enlarged collection chamber section, all of the foregoing being formed from transparent material for easy viewing of the specimens captured. The enlargement at this point is sufficient to effect a substantial slowing of the air being pulled through the collection segment in the collection chamber section, helping to prevent injury to the specimens collected. The foregoing primary purpose also provides an enlarged area for the specimens to be spread upon rather than piling them on top of each other, which could also be injurious.

The foregoing collection segment is joined to an intermediate segment that includes a screen, grid, netting, or other air permeable webbing or lattice structure transverse to the direction of air flow through the collection segment. This allows air to flow through the enlarged collection chamber section in response to the negative pressure gradient while retaining insects in said collection chamber. The reverse, enlarged end of said collection segment is screw threaded, allowing it to interface with and connect to a mating adjacent threaded surface on the intermediate segment. The intermediate segment is likewise provided with another threaded surface allowing it to interface with and connect to a mating adjacent threaded surface of the attachment segment. The attachment segment tapers down from the enlarged end of the collection segment in successive step sections with diameters chosen to allow it to interface and connect in and to varying diameters of hoses, suction tubes or other orifices provided in or leading to is variety of possible suctioning apparatuses.

The open collection end of the collection segment is also provided with a spring biased lid with a latch that can be released, allowing the lid to snap closed over the open nozzle and prevent the escape of any of the specimens captured in the device after the suction/vacuum is turned off. The collection segment, with the intermediate segment attached thereto, can then be conveniently unscrewed and removed from its connection with the attachment segment and placed as a separate unit on a table or other surface for better examination and study of specimens therein. Further explanation of the foregoing components and their function in furthering the goals of the invention will be provided with reference to the drawing figure in the detailed description that follows.

### BRIEF DESCRIPTION OF THE DRAWING FIGURE

The novel features believed to be characteristic of this invention will be set forth with particularity in the claims to be filed with a subsequent non-provisional application. The invention itself, however, both as to its organization and method of operation, together with further object and advantages thereof, may best be understood by reference to the following description taken in connection with the accompanying drawings in which:

FIG. 1 provides an exploded perspective view of a first embodiment of the invention having a spring biased snap down lid, illustrating its component parts and certain preferred dimensions thereof.

FIG. 2A provides a side view of a second embodiment of the invention having a non-spring biased frictional lid, illustrating its component parts.

FIG. 2B provides a perspective view of the second embodiment of the invention having a non-spring biased frictional lid, illustrating its component parts.

FIG. 2C provides a side disassembled perspective view of the second embodiment of the invention having a non-spring biased frictional lid, further illustrating its component parts.

### DESCRIPTION

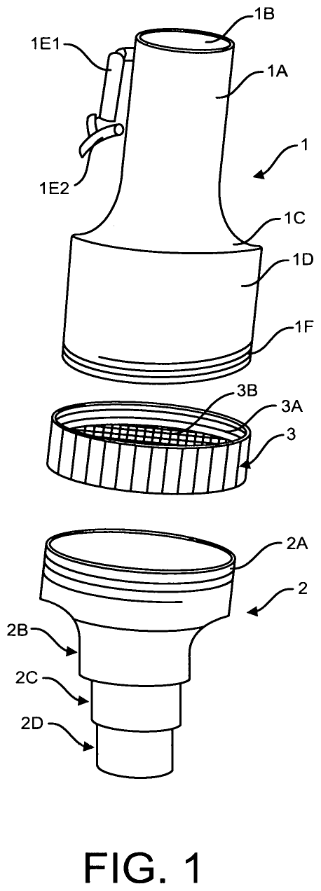

Turning to FIG. 1, which provides further guidance and information in regard to the invention, it will be seen that the invention is comprised of: (i) A collection segment 1 used in capturing and containing insects and the like, (ii) an attachment segment 2 used in attaching the apparatus to a vacuum cleaner or similar suctioning device, and (iii) an intermediate screen segment 3 used to attach these two segments and keep specimens from being sucked into the suctioning device.

The collection segment 1 includes a nozzle section 1A that is advantageously configured as a generally cylindrical tube which has an open end 1B for collection purposes and thereafter flares at transition 1C to form an enlarged collection chamber 1D, all of the foregoing being formed from transparent material for easy viewing of the specimens captured. The enlargement at the transition 1C is sufficient to effect a substantial slowing of the air flow 4 being pulled through collection chamber section 1D and screen 3B, helping to prevent injury to the specimens collected when impacting screen 3B as they are carried through collection segment 1 by air flow 4. The embodiment shown shows a doubling of radius for the collection chamber 1D producing a quadrupling of the cross-sectional area for chamber 1D versus that of nozzle section 1A. Hence the rate of air flow 4 is reduced to ¼ of that in section 1A. This has as its purpose a substantial decrease in the chance of injury to the specimens on impacting screen 3B. It is considered that an increase between 2 and 3 times the radius of the input nozzle 1A is optimal, with the larger increase being more suitable for more vulnerable specimens such as butterflies and moths. However, for ordinary uses, the doubling of the diameter provides a good balance between reducing impact speed without creating an overly wide and therefore more awkward and cumbersome device. In addition to the foregoing primary purpose, the increase in cross-sectional area also provides an enlarged area of screen 3B for specimens to be spread out upon, rather than piling them on top of each other, which could also be injurious as well as an enlarged collection area/volume overall.

Segment 1 is joined to an intermediate segment 3 that includes a screen, grid, netting, or other air permeable webbing or lattice structure 3B transverse to the direction of air flow 4 through the collection segment 1. This allows air to flow through the enlarged collection chamber 1D in response to the negative pressure gradient while retaining insects in said collection chamber 1D. The reverse, enlarged end of said collection segment is screw threaded 1F, allowing it to interface with and connect to a mating adjacent threaded surface 3A in the intermediate segment 3. The intermediate segment is likewise provided with another threaded surface (not shown) allowing it to interface with and connect to a mating adjacent threaded surface 2A of the attachment segment 2. The attachment segment tapers down from its enlarged end adjacent threaded surface 2A in successive step sections 2B, 2C, 2D with diameters chosen to allow it to interface and connect in and to varying diameters of hoses, suction tubes or other orifices provided in or leading to a variety of possible suctioning/vacuum apparatuses.

The open collection end 1B of segment 1 is also provided with a spring biased lid 1E1 with a latch 1E2 that can be released, allowing the lid 1E1 to snap close over the open nozzle end 1B and prevent the escape of any of the creatures captured in the device after the suction/vacuum is turned off. The collection segment 1, with the intermediate segment 3 attached thereto, can then be conveniently unscrewed and removed from its connection with the attachment segment 2 and placed as a separate unit on a table or other surface for better examination and study of specimens therein, thereby further facilitating the goals of the invention in terms of specimen collection for examination and study. After this, the specimen(s) can be released by opening the lid 1E1 and/or by removing intermediate segment 3 from collection segment 1. Alternately, if the specimen or specimens are to be preserved for long-term collection, dissection, or similar uses, they can be quickly and simply euthanized by chemical means while still imprisoned in the collection chamber 1D. By way of example, this may be advantageously be done using an ether soaked cotton ball. If the surface on which the collection segment 1 rests is suitable, such an ether soaked cotton ball can be place thereon and conjoined segments 1 and 3 (with segment 3 at the bottom) can be placed over the cotton ball with the lid 1A1 closed, allowing euthanizing fumes to pass through lattice/screen 3B and permeate the collection chamber 1D. Alternately, while collection chamber 1D is sitting on a suitable flat surface, lid 1A1 can be opened briefly and a suitable euthanizing agent can be deposited in chamber 1D via open collection end 1B.

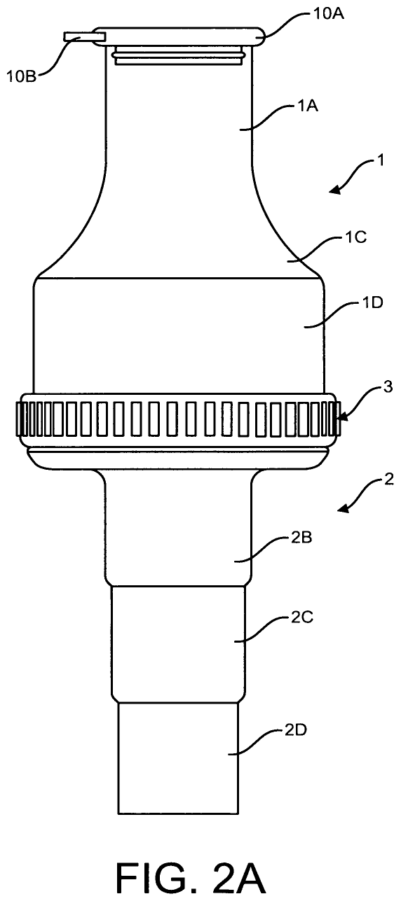

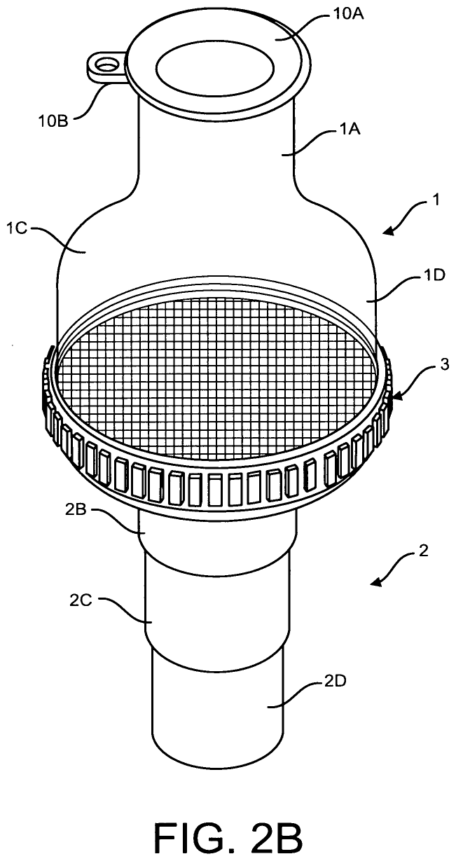

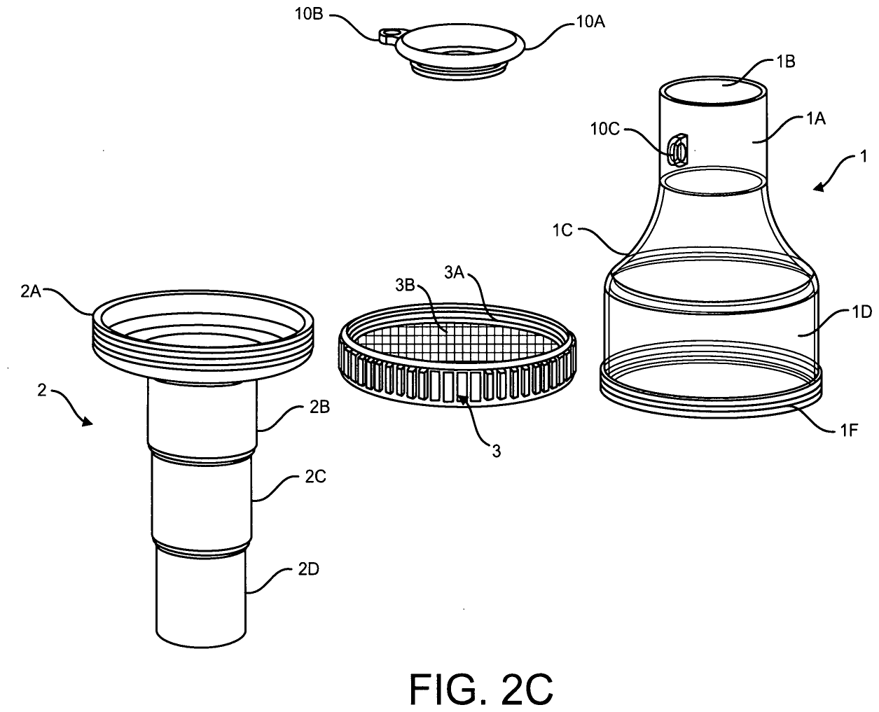

FIGS. 2A-2C provide alternate views of most of the foregoing and also illustrate an alternative cap or lid for the device. In contrast to the spring-biased snap down lid 1E1 illustrated in FIG. 1, the foregoing drawing figures illustrate a more simply configured structure, frictional lid 10A, which snugly fits within collection end 1B and is assisted in its function by a o-ring. Lid 10A also has a connection loop 10B by which it can be attached to a similar connection loop 10C on collection segment 1.

### PARTS LIST

1 Collection segment
1A Nozzle section of collection segment 1
1B Open collection end of collection segment 1
1C Transition from nozzle section to containment section
1D Collection chamber/section
1E1 Lid for open collection end
1E2 Latch for lid for open collection end
1F Threaded end of collection segment
2 Attachment segment
2A Threads for attachment to intermediate segment
2B, 2C, 2D Successive step down sections of attachment segment
3 Intermediate segment
3A threads for attachment to collection segment
3B Screen
4 Air flow direction indicator arrow
10A Frictional lid
10B Connection loop
10C Connection loop

In view of the foregoing, it should be clear that numerous changes and variations can be made without exceeding the scope of the inventive concept outlined. Accordingly, it is to he understood that the embodiment(s) of the invention herein described is/are merely illustrative of the application of the principles of the invention. Reference herein to details of the illustrated embodiment(s) is not intended to limit the scope of the claims, which recite those features regarded as essential to the invention.

1. An apparatus for acquisition and study of invertebrate specimens, comprising:
a collection segment used in capturing and containing insects and the like, wherein said collection segment includes a nozzle section configured as a generally cylindrical tube which has an open end for collection purposes and thereafter flares to form an enlarged collection chamber, all of the foregoing being formed from transparent material for easy viewing of any specimens captured;
an attachment segment used in attaching the apparatus to a vacuum cleaner or similar suctioning device; and
an intermediate screen segment used to attach these two segments together and keep specimens from being sucked into the suctioning device, said segment including an air permeable webbing, lattice structure, screen, grid, or netting transverse to the direction of air flow through the collection segment.
